(19) United States
(12) Patent Application Publication
(10) Pub. No.: US 2026/0108341 A1
(43) Pub. Date: Apr. 23, 2026

(54) METHOD FOR ARTIFICIAL INSEMINATION OF MAMMALS

(71) Applicant: Marc Allan Walther, New Haven, MI (US)

(72) Inventor: Marc Allan Walther, New Haven, MI (US)

(21) Appl. No.: 19/363,348

(22) Filed: Oct. 20, 2025

Related U.S. Application Data
(60) Provisional application No. 63/709,760, filed on Oct. 21, 2024.

(51) Int. Cl. A61D 19/02

(52) U.S. Cl. CPC A61D 19/02; A61D 19/027

(57) ABSTRACT

A method for enhancing artificial insemination (AI) in mammals, particularly bovine livestock, uses a specialized aqueous mastic solution to substantially increase conception success rates from conventional 60-65% to about 95%. The solution comprises ionic minerals including magnesium chloride, calcium chloride, sodium, potassium, and an emulsion of milled mastic gum (Pistacia lentiscus, preferably Chios Mastiha, particulates 15-40 μm) dissolved in water sourced from inland saltwater bodies such as the Great Salt Lake, delivering approximately 72 ionic and trace minerals. The process involves: preparing the uterus by depositing the solution via syringe to maintain pH at 7.35-7.45 and eliminate bacteria; washing donor semen in the solution to isolate healthy, motile sperm and remove debris/reactive elements; and depositing the washed semen directly into the uterus during ovulation, confirmed via luteinizing hormone detection, ultrasound, or chorionic gonadotropin induction.

### CROSS REFERENCE

This application claims the benefit of provisional application no. 63/709,760, filed Oct. 21, 2024, the entirety of which is hereby incorporated by reference.

### FIELD OF THE INVENTION

The present invention relates generally to artificial insemination of mammals, and, more particularly, relates to the use of a mastic formulation during the insemination process that greatly increases the success of the insemination.

### BACKGROUND OF THE INVENTION

Artificial insemination is a well-known process for procreation. While used for humans, it is also widely used for livestock where it is actually the preferred method for livestock propagation. This is particularly true in relation to bovine livestock. Subjecting a heifer or cow to a bull for insemination can result in injury to either of the animals. As a result, artificial insemination is often used to avoid such risk. Artificial insemination in bovine livestock tends to have a success rate of about 60%-65% when done by skilled personnel. Of course, a higher success rate would be preferable.

Therefore, a need exists to overcome the problems with the prior art as discussed above.

### SUMMARY OF THE INVENTIVE EMBODIMENTS

In accordance with some embodiments of the inventive disclosure, there is provided a method for artificial insemination that includes preparing an aqueous mastic solution comprising magnesium chloride, calcium chloride, sodium, potassium, and a mastic emulsion made from a gum powder of pistacia lentiscus. The method further includes determining that a subject to be inseminated is ovulating, applying the mastic solution in a uterus of the subject, and depositing a quantity of washed semen in the uterus.

In accordance with a further feature, the washed semen is prepared by obtaining a semen sample from a donor, and introducing a quantity of the mastic solution to the obtained semen to produce the washed semen.

In accordance with a further feature, applying the mastic solution comprises depositing approximately 3.7 mL into the uterus to maintain pH between 7.35 and 7.45 and eliminate bacteria via pistacia lentiscus gum.

In accordance with a further feature, the mastic emulsion includes approximately 72 ionic and trace minerals sourced from inland saltwater.

In accordance with a further feature, washing comprises selecting healthy sperm.

In accordance with a further feature, the washed semen is prepared by: thawing a semen to obtain thawed semen; and introducing a quantity of the mastic solution to the thawed semen in a washing chamber to produce the washed semen.

In accordance with a further feature, applying the mastic solution comprises depositing approximately 3.7 mL into the uterus and it maintain a pH of the uterus between about 7.35 and 7.45.

In accordance with a further feature, the mastic emulsion is prepared by: milling mastic gum tears into a powder to produce a mastic gum powder having a particulate size of between about 15 micrometers and 40 micrometers, and mixing the mastic gum powder with ionic minerals dissolved in water to form the emulsion.

In accordance with a further feature, the gum powder has a particulate size of less than about 15 micrometers, and the mastic emulsion further includes calcium carbonate milled in a 4 to 1 concentrate ratio with the gum powder.

In accordance with a further feature, the mastic solution includes approximately 72 ionic and trace minerals, sourced at least in part from an inland body of saltwater, to support acid-base balance and sperm motility.

In accordance with a further feature, the mastic solution has an anti-bacterial effect.

In accordance with a further feature, the subject is bovine livestock.

In accordance with some embodiments of the inventive disclosure, there is provided a composition for enhancing artificial insemination in mammals that includes an aqueous emulsion of milled mastic gum derived from pistacia lentiscus having a particulate size of less than 40 micrometers. The composition further includes ionic calcium from a source of calcium chloride or milled calcium carbonate, ionic magnesium from magnesium chloride, and sodium and potassium ions.

In accordance with a further feature, wherein the composition further includes ionic trace minerals in an aqueous solution.

In accordance with a further feature, the milled mastic gum has a particulate size of less than 15 micrometers.

In accordance with some embodiments of the inventive disclosure, there is provided an apparatus for performing artificial insemination in mammals using a mastic solution that includes a syringe configured for trans-pelvic delivery into a uterine cavity, a medical straw or catheter (lumen) coupled to the syringe, adapted to deposit an aqueous mastic solution comprising milled pistacia lentiscus gum emulsion, ionic calcium, ionic magnesium, sodium, potassium, and trace minerals, The apparatus can also include a semen washing chamber or vial integrated with or attachable to the apparatus, that is configured to receive a donor semen sample and the mastic solution, for removing debris and isolating motile sperm. The apparatus is configured to: (a) prepare a uterus of a subject to be inseminated by applying the mastic solution to maintain pH between about 7.35 and 7.45 and provide antibacterial effect; (b) wash the semen sample in the mastic solution; and (c) deposit the washed semen directly into the uterus during ovulation, thereby enhancing conception success to about 95% by bypassing cervical barriers and delivering ionic minerals.

In accordance with a further feature, the medical straw or catheter includes a narrow lumen dimensioned for precise uterine placement while minimizing animal discomfort, and the syringe is pre-calibrated for the 3.7 mL volume of mastic solution.

In accordance with a further feature, wherein the apparatus further includes an ovulation detection module to confirm ovulation timing prior to deposition.

In accordance with a further feature, the mastic solution comprises magnesium chloride, calcium chloride, sodium, potassium, and the milled mastic gum having particulates of less than 40 micrometers.

Although the invention is illustrated and described herein as embodied in a method of artificial insemination, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention. While the method enhances AI success, the mastic solution should be used under veterinary guidance, and statements herein regarding efficacy are not FDA-evaluated.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

“In the description of the embodiments of the present invention, unless otherwise specified, azimuth or positional relationships indicated by terms such as “up”, “down”, “left”, “right”, “inside”, “outside”, “front”, “back”, “head”, “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first”, “second”, “third” and so on are only used for descriptive purposes, and cannot be construed as indicating or implying relative importance.

In the description of the embodiments of the present invention, it should be noted that, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Those skilled in the art can understand the specific meanings of the above-mentioned terms in the embodiments of the present invention according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 shows a flowchart diagram of an artificial insemination method in accordance with some embodiments.

FIG. 2 shows a view of an artificial insemination operation.

FIG. 3 shows a washing chamber, in accordance with some embodiments.

FIG. 4 shows an apparatus for performing artificial insemination, in accordance with some embodiments.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

Artificial insemination (AI) is a reproductive technique performed to breed cattle (among other species) without natural mating. In bovine agriculture, AI involves collecting semen from a bull, processing and preserving it, and then depositing it into a cow's uterus. The inventive embodiments provide for the application of an inventive mastic preparation in addition to the conventional AI techniques to substantially increase the conception rate and success of the AI process.

The inventive process is described herein in the context of bovine insemination. The quantity of material and source of semen will of course vary for other species. The process of insemination commences by preparing the uterus by passing the pelvis with a syringe and medical straw applying about 3.7 mL of the mastic solution, in a bovine application. A different amount would be used for other species of livestock, as is appropriate. The mastic solution maintains the pH of the uterus in a range between about 7.45 and 7.35. Other steps in the process include:
collecting a sperm sample from the donor animal;
washing the sperm sample to remove debris from the sperm sample using the mastic solution; and
placing the washed sperm directly into the uterus using a lumen such as a small catheter/medical straw when the cow is ovulating.

The AI procedure is short and involves minimal animal discomfort and stress, especially compared to the traditional method of having a bull mount the cow. The use of the mastic solution has been found to increase the chance of conception to about 95%. This is accomplished, in part, by controlling the cervix pH with the mastic solution. The mastic solution increases the number of sperm that reach the ovum, and provides numerous ionic minerals and trace elements that are believed to contribute to the insemination success. The mastic solution achieves up to 95% conception rates by: (1) bypassing cervical barriers, pH imbalances, ionic deficiencies, and debris via direct uterine deposition and the mastic gum's antibacterial properties; (2) eliminating physical trauma from bull mounting; (3) enhancing sperm motility and quantity reaching the ovum; and (4) introducing ionic and trace minerals alongside emulsified pistacia lentiscus gum.

### Preparation for Insemination

Because the timing of AI is critical, checking for signs that the cow is ovulating is crucial. To do this, the veterinarian might use a urine ovulation predictor kit which detects when the animal's body produces a surge or release of luteinizing hormone (LH), which causes the ovary to release an ovum. Alternatively, a test an imaging test of ovaries and egg growth, called transvaginal ultrasound can be used. An injection of chorionic gonadotropin (CG) or other compositions to make the cow ovulate one or more eggs can be given. AI is typically performed within two days when tests show signs of ovulation.

### Preparing the Semen Sample

A vial of frozen donor bull sperm can be thawed and prepared. The sample is washed in the mastic solution which separates the highly active, healthy sperm from lower-quality sperm. Washing in the mastic solution also removes elements that could cause reactions, such as serious cramps, if placed in the uterus. The likelihood of an animal becoming pregnant rises by using a small, highly concentrated sample of healthy sperm with the mastic solution, using about 3.7 mL of the mastic solution.

### Composition and Preparation of the Mastic Solution

The composition will include a source of ionic calcium, and a source of ionic magnesium, both of which are dissolved in water containing dissolved ionic trace minerals and mastic gum (pistacia lentiscus). The calcium of the composition can be calcium carbonate that is milled to a powder in a 4 to 1 ratio including the mastic gum. In one aspect, this forms a 4 to 1 concentrate powder including the mastic gum, ensuring efficient ionization and emulsification. The method can include the steps of: (a) milling mastic gum tears into a powder; and (b) mixing the mastic gum powder with ionic minerals dissolved in water to emulsify the mastic gum so as to produce a solubilized mastic gum liquid solution. The mastic gum is derived from an herb that has been used by many in antiquity because of its antibacterial pharmaceutical properties. Thus, the mastic solution has anti-microbial properties in additional to producing a stable pH range. The blend of proprietary ingredients in the mastic solution enables delivery of the benefits of mastic gum in an optimum system.

The calcium carbonate can be milled to between about 15 micrometers to about 40 micrometers before it is added to the composition, although the particulate size of the milled calcium carbonate could be more or less than the specified range. The milled calcium carbonate can be added to water in which it ionizes into calcium and carbonate ions as it dissolves into liquid form. The calcium carbonate can be milled to a particulate size forming a 4:1 concentrate powder with the mastic gum, ensuring efficient ionization into calcium and carbonate ions upon dissolution. Mastic gum tears are mechanically milled to less than 15 micrometers in some embodiments for optimal emulsification.

In a next step, mastic gum tears can be mechanically milled into a powder. The mastic gum herb may be milled to a powder having a particulate size of between about 15 micrometers to about 40 micrometers. In some embodiments, the mastic gum is milled into a powder having a particulate size of less than about 30 micrometers. In some embodiments, the mastic gum is milled into a powder having a particulate size of less than about 15 micrometers.

Mastic gum used in the processing method may be Chios Gum Mastic (also known as Chios Mastiha), an air-dried resinous exudation from P. Lentiscus L (family Anacardiaceae), a small shrub-like evergreen tree. The blend of the proprietary ingredients in the mastic solution in combination with the mastic gum enables delivery of the benefits of the mastic gum in an optimum delivery system.

The mastic gum powder is then mixed with ionic minerals dissolved in water (emulsion). The water and/or the minerals can be sourced from an inland body of saltwater (e.g., the Great Salt Lake). In exemplary formulations, the solution includes approximately 72 ionic and trace minerals to support acid-base balance and overall efficacy.

Ingredients of the Mastic include Magnesium Chloride, Calcium Chloride, Sodium, Potassium, and mastic emulsion as described.

The pH of blood is closely maintained between 7.45 and 7.35. This fact greatly relays the importance of careful regulation of hydrogen ion concentration in the body. The pH of the uterus varies between species and throughout the estrous cycle. For example, in non-pregnant mammals, the pH of the uterine cavity is close to neutral, and in the upper part of the cavity it can even be alkaline, ranging from 7.0-7.8. This variation underscores the need for precise pH control during AI, as provided by the mastic solution. Sperm activity and motility are significantly impacted by pH levels, and the optimal pH for sperm viability and motility is between 7.0 and 8.5. An imbalanced pH can hinder sperm's journey towards the egg, affecting the increased percentage chances of successful conception.

By preventing excessive fluctuations in acid-base balance, the body maintains a healthy status quo. Maintaining the complex functioning of the body's tightly regulated pH system requires regulating proper mineral and trace mineral levels to sustain optimal and healthful balance. While the mastic solution enhances AI outcomes, it is not intended to diagnose, treat, cure, or prevent any disease; users should consult qualified professionals for veterinary advice.

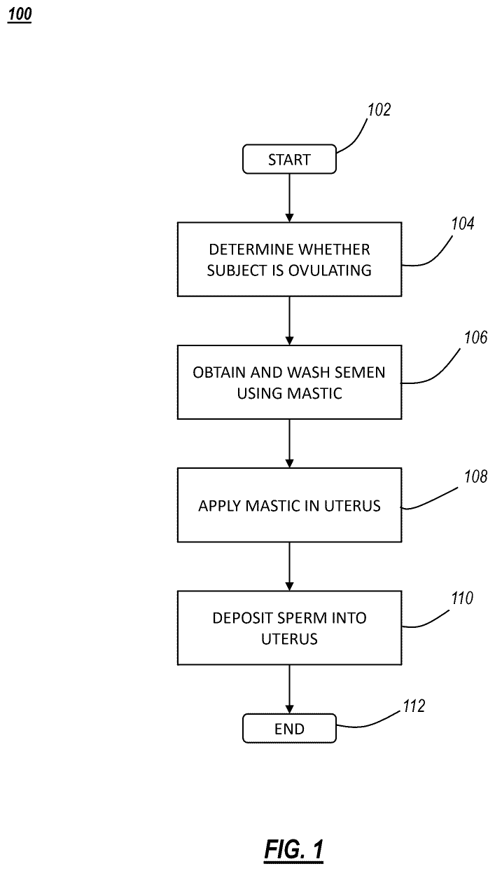

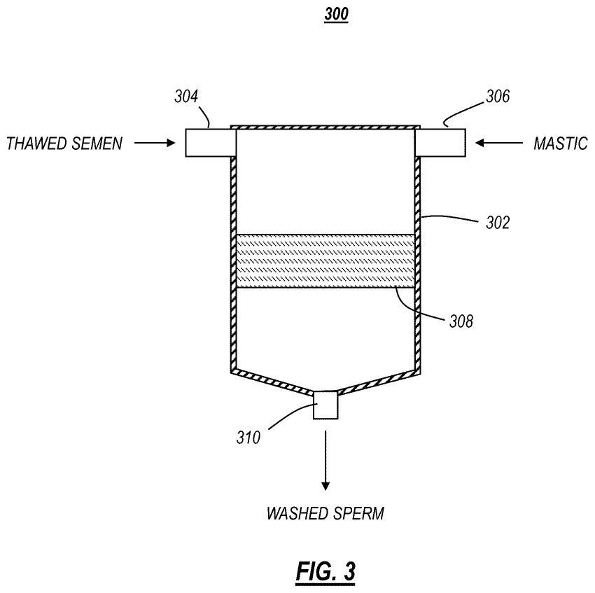

FIG. 1 shows a flowchart diagram of an artificial insemination method 100 in accordance with some embodiments. At the start 102 the semen can be frozen and ready to be thawed. A first step 104 is to determine that the subject is ovulating. This can be done by any well known means as is conventional. Once it has been determined that the subject is ovulating, then in step 106 the semen is obtained, such as by thawing a frozen sample in a conventional manner. The thawed semen is then washed using the prepared mastic solution as described hereinabove. The washing can be done in a variety of ways, including the use of a washing chamber as shown in FIG. 3. But other methods such as, for example, centrifugal separation, can be used. The washing is intended to separate highly motile sperm from dead or low motile sperm, and other debris that may be present. The presence of the mastic solution has been found to increase the viability of motile sperm through the process. In addition, a prescribed quantity of the mastic is further applied to the subject's uterus in step 108. Steps 106 and 108 should be performed timely with each other to optimize the effect and provide the best chance of insemination success. Likewise, in step 110, the washed sperm is deposited into the uterus immediately after depositing the mastic, or at the same time as depositing the mastic in step 108. After step 110, the process ends 112 by monitoring the subject at a suitable later time to confirm insemination success in a conventional manner.

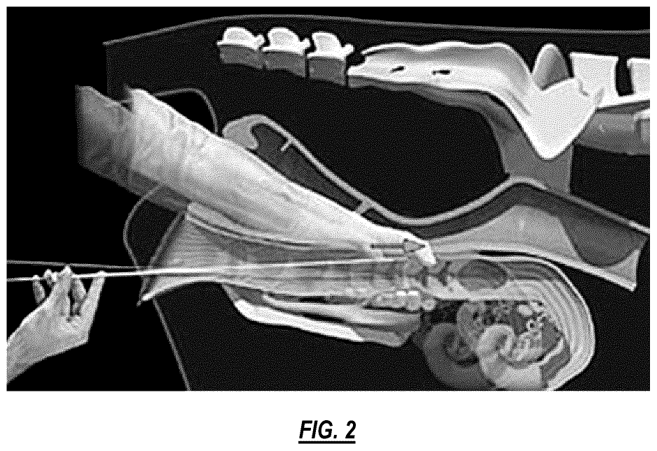

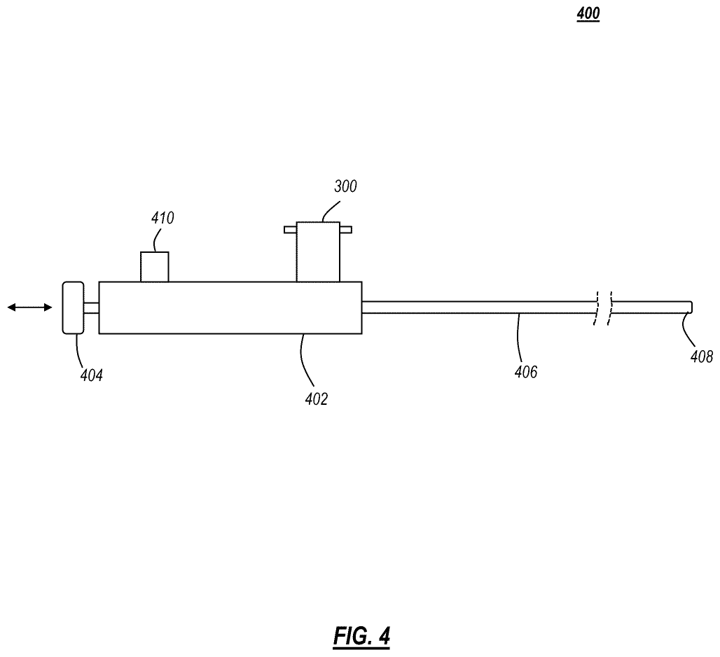

FIG. 2 shows a view of an artificial insemination operation. According to the inventive disclosure, the physical method of performing the artificial insemination is very similar to the conventional method, as shown here. However, rather than a conventional syringe/lumen, an apparatus as shown in FIG. 4 can be used. The method is typically performed by an experienced technician, or someone with equivalent experience. In general, first the technician will wipe the cow's vulva with a clean paper towel or disinfectant to remove dirt and feces, reducing contamination risk. The technician wears a lubricated shoulder-length glove and insert their non-dominant arm into the cow's rectum. The technician then locates and grasps the cervix through the rectal wall. This “recto-vaginal” method allows guidance while keeping the tract clean. With their dominant hand, the technician gently inserts the sheathed AI gun into the vagina at a 30-45° upward angle to avoid the urethra. The technician advances the AI gun to the cervix (about 12-18 inches in), using their rectal hand to manipulate the cervix forward and straighten the vaginal folds. The technician then threads the AI gun tip through the cervical rings (3-5 firm ridges) into the uterine body. This is the position shown in FIG. 2. The technician feels for a “pop” as the gun tip enters through the cervical rings, avoiding excessive force to prevent injury. The target is just beyond the cervix, in the uterine body or horns. Once the technician has maneuvered the AI gun tip into position, the technician slowly depresses the plunger of the AI gun to release half the semen (and mastic) into one horn, then withdraws the AI gun slightly and deposits the rest in the other horn, or the body, for even distribution. This maximizes sperm access to the ovum. The technician then gently removes the gun and arm.

FIG. 3 shows a washing chamber 300, in accordance with some embodiments. The washing chamber 300 is used for washing the thawed semen to collect the motile sperm and remove dead sperm and debris from the semen. The washing chamber includes a main chamber 302 can be a generally hollow cylindrical body, having access ways 304, 306 to allow thawed semen and mastic to be introduced into the upper portion of the main chamber 302, above the filter medium 308. The filter medium is configured to allow motile sperm and mastic to pass through and collect in the lower portion of the main chamber 302, under the filtration medium. The bottom of the main chamber can be sloped from the sidewalls to an exit port 310. The exit port 310 can, in some embodiments, be coupled to an AI gun to allow the filtered semen/sperm/mastic to collect into a plunger chamber of the AI gun.

FIG. 4 shows an apparatus 400 for performing artificial insemination, in accordance with some embodiments. The apparatus is an artificial insemination gun with an integrated washing chamber 300. The apparatus 400 can include a plunger chamber 402 in which a plunger 404 is operated to push the washed semen and mastic through a lumen 406 and out of the distal end 408 of the lumen into the cow, according to otherwise conventional AI techniques. Alternatively, a more conventional AI gun can be used, loading the conventional AI gun from the washing chamber 300 (e.g. port 310). The lumen 406 should be long enough so that no portion of the plunger chamber 402 needs to be inserted into the cow. The inner diameter of the lumen 406 is such that only a negligible amount of material is left behind in the lumen when the plunger 404 is fully depressed. The apparatus can also include an ovulation detection module 410 that can be used to confirm ovulation is occurring. The ovulation detection module 410 can be connected, for example to a sensor at the distal end 408 of the lumen that is response to ovulation conditions, as is well known.

A method for artificial insemination using a mastic solution has been disclosed that increases success rates through pH control, mineral delivery, and antibacterial properties.

What is claimed is:

1. A method for artificial insemination, comprising:
preparing an aqueous mastic solution comprising magnesium chloride, calcium chloride, sodium, potassium, and a mastic emulsion made from a gum powder of pistacia lentiscus;
determining that a subject to be inseminated is ovulating;
applying the mastic solution in a uterus of the subject; and
depositing a quantity of washed semen in the uterus.

2. The method of claim 1, wherein the washed semen is prepared by:
obtaining a semen sample from a donor; and
introducing a quantity of the mastic solution to the obtained semen to produce the washed semen.

3. The method of claim 1, wherein applying the mastic solution comprises depositing approximately 3.7 mL into the uterus to maintain pH between 7.35 and 7.45 and eliminate bacteria via pistacia lentiscus gum.

4. The method of claim 1, wherein the mastic emulsion includes approximately 72 ionic and trace minerals sourced from inland saltwater.

5. The method of claim 2, wherein washing comprises selecting healthy sperm.

6. The method of claim 1, wherein the washed semen is prepared by: thawing a semen to obtain thawed semen; and introducing a quantity of the mastic solution to the thawed semen in a washing chamber to produce the washed semen.

7. The method of claim 1, wherein applying the mastic solution comprises depositing approximately 3.7 mL into the uterus and it maintain a pH of the uterus between about 7.35 and 7.45.

8. The method of claim 1, wherein the mastic emulsion is prepared by: milling mastic gum tears into a powder to produce a mastic gum powder having a particulate size of between about 15 micrometers and 40 micrometers; and mixing the mastic gum powder with ionic minerals dissolved in water to form the emulsion.

9. The method of claim 1, wherein the gum powder has a particulate size of less than about 15 micrometers, and the mastic emulsion further includes calcium carbonate milled in a 4 to 1 concentrate ratio with the gum powder.

10. The method of claim 1, wherein the mastic solution includes approximately 72 ionic and trace minerals, sourced at least in part from an inland body of saltwater, to support acid-base balance and sperm motility.

11. The method of claim 1, wherein the mastic solution has an anti-bacterial effect.

12. The method of claim 6, wherein the subject is bovine livestock.

13. A composition for enhancing artificial insemination in mammals, comprising:
an aqueous emulsion of milled mastic gum derived from pistacia lentiscus having a particulate size of less than 40 micrometers;
ionic calcium from a source of calcium chloride or milled calcium carbonate;
ionic magnesium from magnesium chloride; and
sodium and potassium ions.

14. The composition of claim 13, further comprising ionic trace minerals in an aqueous solution.

15. The composition of claim 13 wherein the milled mastic gum has a particulate size of less than 15 micrometers.

16. An apparatus for performing artificial insemination in mammals using a mastic solution, comprising:
a syringe configured for trans-pelvic delivery into a uterine cavity;
a medical straw or catheter coupled to the syringe, adapted to deposit an aqueous mastic solution comprising milled pistacia lentiscus gum emulsion, ionic calcium, ionic magnesium, sodium, potassium, and trace minerals;
a semen washing chamber or vial integrated with or attachable to the apparatus, configured to receive a donor semen sample and the mastic solution for removing debris and isolating motile sperm;
wherein the apparatus is configured to: (a) prepare a uterus of a subject to be inseminated by applying the mastic solution to maintain pH between about 7.35 and 7.45 and provide antibacterial effect; (b) wash the semen sample in the mastic solution; and (c) deposit the washed semen directly into the uterus during ovulation, thereby enhancing conception success to about 95% by bypassing cervical barriers and delivering ionic minerals.

17. The apparatus of claim 16, wherein the medical straw or catheter includes a narrow lumen dimensioned for precise uterine placement while minimizing animal discomfort, and the syringe is pre-calibrated for the 3.7 mL volume of mastic solution.

18. The apparatus of claim 16, further comprising an ovulation detection module to confirm ovulation timing prior to deposition.

19. The apparatus of claim 16, wherein the mastic solution comprises magnesium chloride, calcium chloride, sodium, potassium, and the milled mastic gum having particulates of less than 40 micrometers.
